(19) United States
(12) Patent Application Publication
(10) Pub. No.: US 2017/0218661 A1
(43) Pub. Date: Aug. 3, 2017

(54) Foot operated door opener

(71) Applicant: Robert A. Fraychineaud, JR., Midland, NC (US)

(72) Inventor: Robert A. Fraychineaud, JR., Midland, NC (US)

(21) Appl. No.: 15/012,984

(22) Filed: Feb. 2, 2016

(51) Int. Cl. E05B 53/00; E05B 1/00

(52) U.S. Cl. CPC E05B 53/003; E05B 1/0053

(57) ABSTRACT

A foot operated door opener device that includes a pair of pedals near the lower corner of the door below the door knob/lever. The pedals are connected to a shaft that pivots within housings that are mounted to either side of the door across from one another. The pedal is hooked to a flexible strap or cable that runs vertically up to the knob/lever horizontal shaft. The cable or strap is connected and wrapped around the rotatable knob/lever shaft. As the operator depresses the pedal the cable or strap is pulled downward and rotates the knob/lever unlatching the door. The pedal is pulled or pushed by the operators' foot/shoe to open. Once the operator is through the doorway, the operator can close and re-latch the door by pulling or pushing the door pedal by foot without ever having to touch the knob/lever handle with their hands.

### BACKGROUND OF INVENTION

Field of Invention

This invention falls within the art of devices designed to unlatch, open, close, and re-latch a pedestrian door. This invention was developed so that the operator could unlatch, open, close, and re-latch a door without having to utilize their hands to do so. Further, this invention was developed so that the operator could carry objects while operating a latched door without having to free their hands to do so. Other benefits of this invention are the avoidance of transferring germs by hand via a door knob or lever needed to unlatch, open, close and re-latch a door. Another benefit would be to persons with hand disabilities or missing a hand preventing them to unlatch, open, close and re-latch a door while carrying items with an arm.

Background Art

Prior art related to this device is much more crude and cumbersome and only operable from one side of the door. Many of the earlier devices were designed to unlatch and re-latch a typical door from only one side. Some other devices within this art realm are not designed to unlatch a latched door at all but only to be able to open a door using a foot/shoe. This device is operable from either side of a typical pedestrian door. This device was designed to eliminate the need to have a hand free to unlatch, open, close, and re-latch a typical pedestrian door knob/lever.

### BACKGROUND OF THE INVENTION

This inventor's desire to invent a device where the operator could unlatch, open, close, and therefore re-latch a typical residential door knob/lever without having to use their hands is what motivated this inventor to invent this device. A door knob or lever handle that latches and unlatches a door typically must be operated with one of the operators' hands dictating that at least one of the hands must be free and empty to be able to grip and operate the knob/lever. This invention eliminates the necessity of an operator to have either hand empty, free, or requiring to touch the knob/lever by hand to unlatch, open, close and therefore re-latch a typical interior or exterior door from either side or direction.

### SUMMARY OF THE INVENTION

It is the purpose of this invention to make it possible for a person to unlatch, pull/push open, walk through, turn, close and re-latch a door all without utilizing the persons' hands but instead their foot. By utilizing this device a person is able to continue to hold objects in both of their hands and operate a door latch without having to free up either hand. Also for many doors that hand hygiene is of concern, this invention eliminates the necessity to expose the operators' hands to any germs, viruses, or any other contaminants that may be on the knob/lever.

It must be mentioned that for each part that has been drawn and enumerated here there may be alternative parts that would accomplish the same function. For example different pedal shapes and configurations could take the place of these but accomplish the same function. A different type of cable/strap or other connection between the knob/lever shaft and the pedal may be used to accomplish the same function.

Other versions and embodiments may reveal themselves or become apparent to other craftspeople and artisans skilled in this art that will fall within these claims.

### DESCRIPTION OF THE SEVERAL VIEWS OF THE DRAWINGS

FIG. 1) depicts an elevation view of the invention installed on a face side of a door.

FIG. 2) depicts an elevation view of the invention installed onto a door from the latch/edge view of the door.

FIG. 3) depicts a plan view of the invention installed onto the door from a vertical view looking from the top edge of the door down.

FIG. 4) depicts the same view as FIG. 3 but much closer.

FIG. 5) depicts an elevation view of the tubular mounting housing without the pedal installed.

FIG. 6) depicts a side view of the tubular mounting housing with the connecting shaft protruding out of the tubular housing.

FIG. 7) depicts an elevation view of the tubular mounting housing with the pedal, “S” hook, and strap assembled.

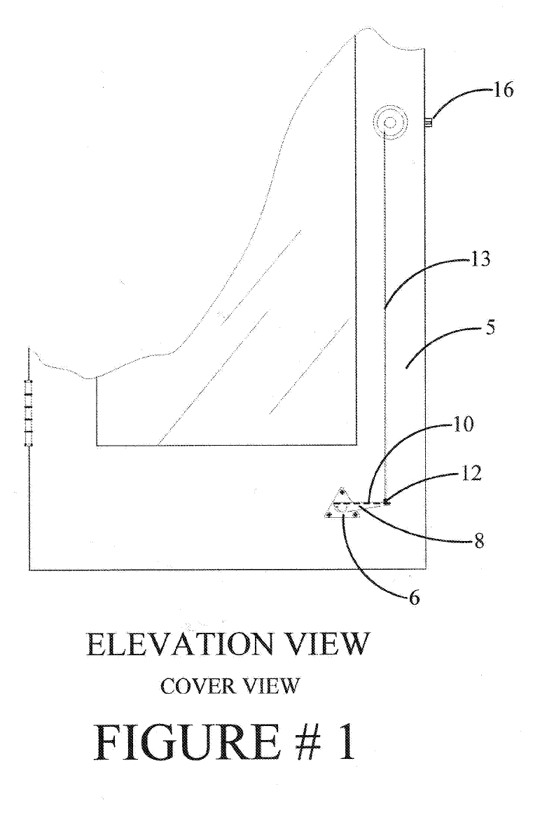

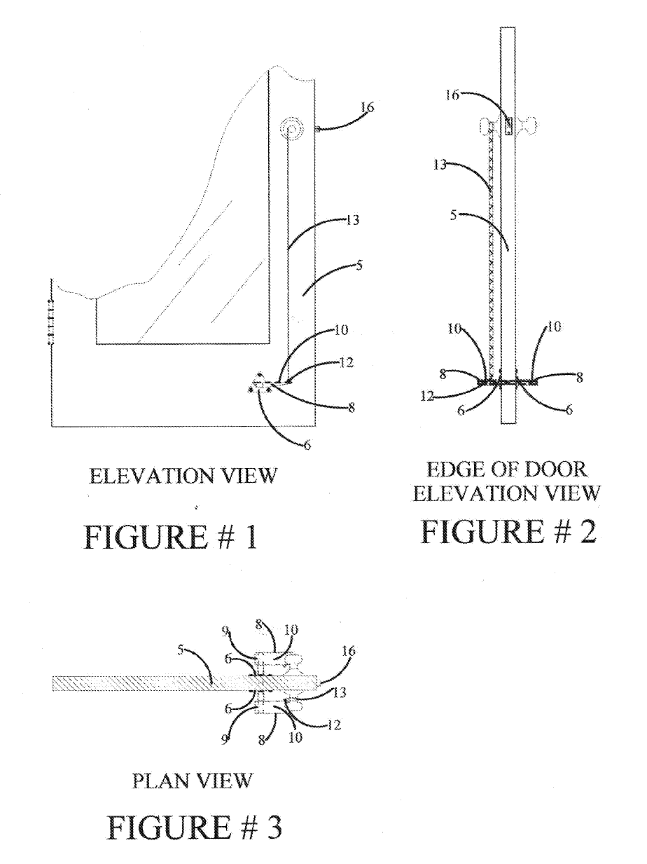

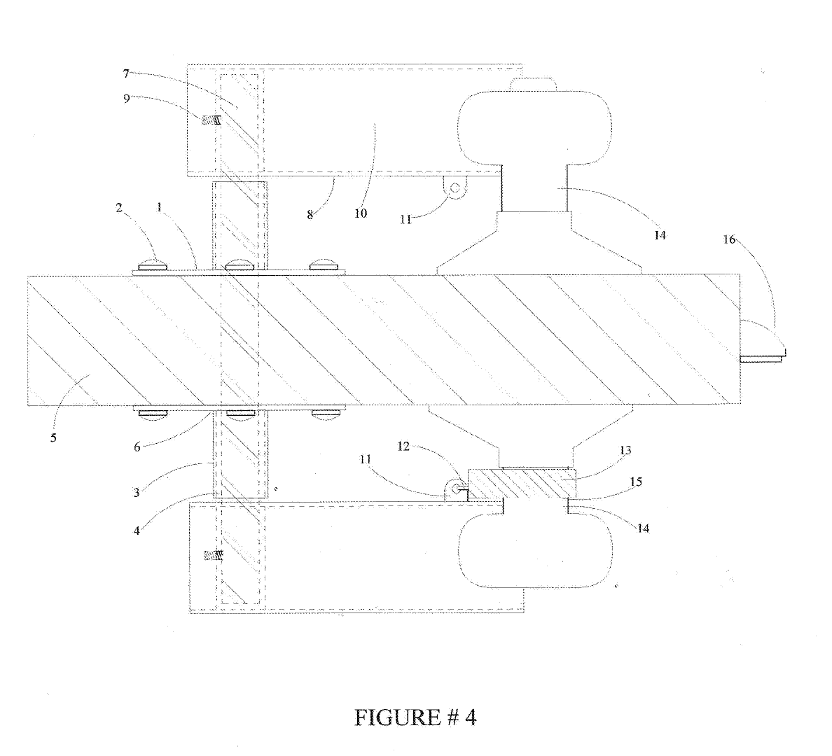

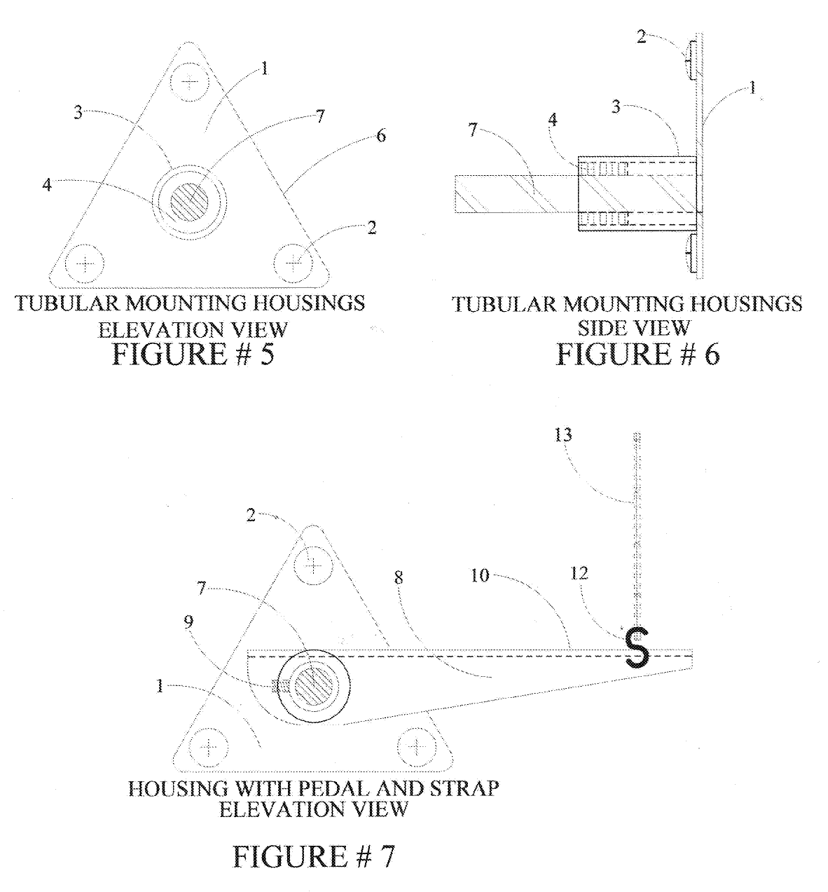

### DETAILED DESCRIPTION OF THE INVENTION

A foot operated door opener that includes two pedals, two tubular mounting housings, a connecting shaft, a strap and/or cable and a flexible/gripping material. The two tubular mounting housings are fastened to the bottom portion of the door. Each of the two housings is located on either side of the door, in line with a hole drilled completely through the door, and with one another both vertically and horizontally. A shaft runs through both mounting housings and the drilled hole in the door. The shaft has a pedal on each end fastened to it. An “S” type connector fastens the end of a cable or strap to a tab located near the thinner/smaller end of one of the pedals. The upper/other end of the cable or strap runs up the door vertically and is wrapped around the flexible/gripping material that is wrapped around directly to the smaller rotating housing of the lever or door knob. When either of the pedals is depressed the force pulls on the cable/strap which turns the door handle or lever shaft and causes an unlatching of the door. The operator then is able to pull or push the pedal horizontally causing the door to open. Once the operator is beyond the door way, the operator can turn and place a foot on the other pedal and pull or push the door closed. The result is that a latched door can be unlatched, opened, closed, and re-latched by an operator all hands free.

What is claimed is:

1) A foot operated door opener that includes two pedals, two tubular mounting housings, a connecting shaft, a strap and/or cable and a flexible/gripping material.

2) The device in claim 1) has two steel tubular mounting housings 6 in FIG. 5, 6. The housings 6 consist of a steel mounting plate 1 that is fastened to the door 5 with screws 2, a section of tubing 3 that is welded to the mounting plate 1, and a flanged nylon bushing 4 that is inserted in the end of the tubing.

3) The steel tubular housings 1 are fastened near the bottom portion of the door 5, one each on either side of the door 5, in line with a drilled hole and in line with one another both vertically an horizontally.

4) The housings in claim 2) have a steel connecting shaft 7 extending through the drilled hole and through both mounting housing bushings 4 on either side of the door 5.

5) The steel connecting shaft 7 in claim 4) has a steel pedal 8 fastened on each end of it using a threaded fastener 9 tightened, locking each pedal onto the shaft 7 ensuring that both pedals 8 move in unison.

6) Each of the steel pedals in claim 5) has a non-slip grip surface 10 applied to the top of the pedals for excellent foot/shoe grip.

7) Each of the steel pedals in claim 5) has a tab with a hole 11 near the thinner/smaller end of one of the pedals 8 to connect an “S” type hook 12 which also connects to the end of the cable or strap 13.

8) The cable or strap 13 in claim 7) upper end runs up the door vertically and is connected to the shaft of a typical door knob/lever 14 with a flexible/gripping material 15 that is wrapped around the door knob/lever shaft 14.

9) When either of the pedals in claim 5) are depressed the force is transferred to the cable/strap in claim 7) which rotates the door handle or lever shaft 14 causing an unlatching of the door latch.

10) The operator is then able to pull to them self or push away from them self the pedal in claim 5) horizontally causing the door to open.

11) Once the operator is throught the doorway, they can place a foot on the other pedal in claim 4) and pull to or push away to close and re-latch the door.

12) The result is that a typically latched door can be unlatched, opened, and closed all hands free.

13) This device will benefit individuals that are hand handicapped. This device provides them the ability to unlatch, open, close, and re-latch a door all hands free.

14) The hands-free operation will prevent the transfer of germs onto the door handle/knob by eliminating the need to use a hand to touch a knob/lever to unlatch, open, close, and re-latch a door.
